(19) United States
(12) Patent Application Publication
(10) Pub. No.: US 2003/0140794 A1
(43) Pub. Date: Jul. 31, 2003

(54) Foam filter and the manufacturing method thereof

(76) Inventors: Chao-Ming Wang, Taichung (TW); Kuo-Cheng Chiu, Taipei (TW)

Correspondence Address: BACON & THOMAS, PLLC, 625 SLATERS LANE, FOURTH FLOOR, ALEXANDRIA, VA, 22314

(21) Appl. No.: 10/329,555

(22) Filed: Dec. 27, 2002

(30) Foreign Application Priority Data
Dec. 28, 2001 (TW) 90132966

(51) Int. Cl. B01D 46/00

(52) U.S. Cl. 96/226; 55/524

(57) ABSTRACT

A foam filter and the manufacturing method thereof is disclosed. The method for manufacturing a foam filter includes the following steps: First, mixing the polyvinyl alcohol (PVA) with water by heating until the PVA is dissolved to form a solution (A) and then cooling said solution (A). At the same time, mixing the vegetable starch with water to form a paste-type solution (B). After that, mixing said solution (A) with said solution (B) to form a solution (C) followed by adding formaldehyde, catalyst and active carbon into said solution (C) to form a paste mixture. Then soaking a polyurethane (PU) foam into said paste mixture and heating said paste mixture to acetalize said PVA therein. Finally, cooling said paste mixture.

The foam filter of the present invention is used for filtering the impurities, the toxins, the odors, or the molds in the air or water.

### BACKGROUND OF THE INVENTION

1. Field of the Invention

The present invention relates to a foam filter and the manufacturing method thereof and, more particularly, to a foam filter suitable for filtering the impurities, the toxins, the odors, or the molds in the air or water.

2. Description of Related Art

Most of the air-filtering masks sold in the market include two non-woven fabrics and an active-carbon-containing fiber layer sandwiched between these two non-woven fabrics. The non-woven fabric layers in these air-filtering masks are used for filtering dust and particles. The function of the fiber layer combined with active carbons is to remove and adsorb the toxic compounds in the air. However, the structure of the commercial air-filtering mask is too simple and the filtering efficiency is poor since the active carbon in the thin fiber layer has limited removing capability for toxic compounds, and the size of the air mesh in the non-woven fabrics is too big to filter the particles completely. Therefore, the commercial air-filtering masks can provide only very simple filtering for limited amounts of pollutant in the air or in smoke. For some serious situations such as fire accident exits or a serious air-polluted environment, the commercial masks with simple structures may not filter out the toxic compounds efficiently or provide protection from inhaled smoke, particles, toxic gas, or high temperature gas. Thus a filter for masks or respirators capable of filtering out particles and toxic gas in smoke and permeating enough oxygen through the filter to be breathed in a polluted area is needed. Especially, a soaking-for-function type filter for masks or respirators will be much more convenient and more efficient for escaping from fire-accident places.

It has been known for a long time that polyurethane (PU) foam can provide gentle softness for human skin contact, and the size of the pores or the mesh of the foam can be well controlled during the manufacturing process. Recently, the porosity percentage ratio, i.e. the pore volume to total volume, can be easily adjusted to even 95% for PU foam. Therefore, PU foams become the most popular porous foam material. In addition to the softness suitable for human skin contact, the air-permeability of PU foam is also high. Therefore, PU foam is also used as a filter in air conditioners and aquaria because it is light, ventilative, and soft. However, the filtering and absorption capabilities of PU foam are poorer than those of PVA (polyvinyl alcohol). Moreover, frequent corrosion is also another serious drawback keeping PU foam from being a good candidate for air-filtering materials.

It has been known that active carbons can absorb many kinds of reactive compounds in the air or in the solution. However, in most cases, limited filtering efficiency is found for commercial air-filtering masks because of poor adhesion of active carbons attached to the fibers on the filter. So far, the surface of the non-woven fabric of the commercial air-filtering masks is coated with a layer of active carbon. Since the adhesion between the active carbons and the fabric of the commercial air-filtering masks is poor, the density of active carbon coated is not high enough for effective adsorption. Therefore, the adhesion between the active carbons on the fabric matrix must be improved to get better adsorption for toxic compounds in the air.

As we know, polyvinyl alcohol (PVA) is a good material for adsorbent and filter. For a PVA foam having a density ranging from 0.01 to 0.03 g/cm³, it can adsorb water of more than five times the weight of the PVA foam. In addition, the adhesion, the solvent-resistance, and the rubbing-resistance of PVA foam is better than those of PU foam. Hence, PVA foams meet the basic requirement for being a material for a filter. Unfortunately, the structure of PVA foam is too dense to percolate the air. Therefore, PVA foam cannot be used as a sole material for air-filter. Moreover, as PVA foam is soaked with water, the water will fill the pores or the holes inside the PVA foam, and further stop the ventilation of air through pores or the holes inside the PVA foam. Therefore, soaked PVA foam is not a good material for an air-filtering mask.

Therefore, it is desirable to provide an improved speech recognition method to mitigate and/or obviate the aforementioned problems.

### SUMMARY OF THE INVENTION

The object of the present invention is to provide a method for manufacturing a foam filter integrating PU foam, PVA, and active carbon to provide a material for filtering the impurities, the toxins, the odors, and molds in the air and water.

The other object of the present invention is to provide a foam filter, which is anti-mildew, antiseptic, toxin-removing, and ventilative.

To achieve the object, the method for manufacturing a foam filter of the present invention includes the following steps. First, mixing the polyvinyl alcohol (PVA) with water by heating and stirring until the PVA is dissolved to form a solution (A) and then cooling said solution (A). At the same time, mixing the vegetable starch with water by heating and stirring to form a paste-type solution (B). After that, mixing said solution (A) with said solution (B) completely to form a solution (C) followed by adding formaldehyde, catalyst and active carbon into said solution (C) to form a paste mixture. Then soaking a polyurethane (PU) foam into said paste mixture and heating said paste mixture to acetalize said PVA therein. Finally, cooling said paste mixture and washing said foam.

To achieve the object, the foam filter of the present invention is prepared by coating a layer of mixture containing polyvinyl alcohol (PVA) and active carbon on a polyurethane (PU) foam, wherein said mixture is made by mixing at least 20 to 70 wt % of PVA solution, 10 to 60 wt % of vegetable starch paste, 3 to 30 wt % of formaldehyde, 2 to 25 wt % of catalyst, and 0.5 to 40 wt % of active carbon.

Other objects, advantages, and novel features of the invention will become more apparent from the following detailed description when taken in conjunction with the accompanying drawings.

### BRIEF DESCRIPTION OF THE DRAWINGS

FIG. 1 is a diagram of a foam filter according to the present invention.

FIG. 2 is a cross-sectional diagram of the PU structure of the foam filter according to the present invention.

### DETAILED DESCRIPTION OF THE PREFERRED EMBODIMENT

The present invention relates to a foam filter and the manufacturing method thereof. The manufacturing method comprises three major steps: i.e. preparation of raw materials, coating, and foaming. In the raw materials preparatory step, individual solutions such as 20-70 wt % of polyvinyl alcohol (PVA) solution, 10-60 wt % of a vegetable starch solution, 3-30 wt % of formaldehyde, 2-25 wt % of catalyst, 0.5-40 wt % of active carbon, and a polyurethane (PU) foam are prepared. Preferably, the weight ratio of polyvinyl alcohol (PVA) to water in the polyvinyl alcohol (PVA) solution of the present invention ranges from 1:4 to 1:15. Preferably, the weight ratio of vegetable starch to water of the vegetable starch solution of the present invention ranges from 1:2 to 1:20. Moreover, it is preferred that the starting concentration of formaldehyde is 35 wt % or more, the catalyst is hydrochloric acid with a starting concentration of 30 wt % or more, and the porosity of the polyurethane (PU) foam ranges from 20 to 60 ppi (pores-per-linear-inch). The polyvinyl alcohol (PVA) solution of the present invention is formed by the steps in the following sequence: mixing PVA with water; heating said PVA mixture at a temperature preferably ranging from 80 to 120° C.; stirring said PVA mixture to dissolve the PVA; and cooling said PVA mixture at a temperature preferably ranging from 20 to 70° C. The vegetable starch solution of the present invention is made by the steps in the following sequence: mixing the vegetable starch with water; and then heating and stirring said vegetable starch mixture to form a paste-type solution at a temperature preferably ranging from 20° C. to 60° C. The time for stirring is preferably from 5 to 30 minutes.

After all the materials are prepared, it is time to start the coating and foaming step. First, mixing the polyvinyl alcohol (PVA) solution with the vegetable starch solution completely; and then adding formaldehyde, hydrochloric acid, and active carbon into said mixture of polyvinyl alcohol (PVA) solution and vegetable starch solution one after another to form a paste mixture. The amount of active carbon added depends on the actual demand. A foaming agent is selectively added to the paste mixture to aid the polyvinyl alcohol (PVA) solution to foam and increase the porosity. Preferably, the foaming agent is calcium carbonate. The amount of foaming agent to add ranges from 0.02 to 1 wt %. Good adhesion, fluidity, and shaping ability allows PVA to be coated on the surface of PU foam (even on the surface of the pores inside the PU foam) as a thin film by soaking a bulk of PU foam into the paste mixture. Then the coated PVA is further acetalized and foamed by heating, wherein the heating temperature preferably ranges from 40 to 80° C. The reaction time for acetalizing PVA is preferably less than 24 hours. Ideally, the reaction time for acetalizing PVA ranges from 4 to 10 hours. After the reaction is accomplished, the paste mixture is cooled down and then washed, dehydrated, and trimmed in various shapes.

The selection or the combination of raw materials such as porous PU polymer materials, PVA, and active carbon is very important for the filter of the present invention. If only PVA and active carbon are included, the viscosity of PVA will be lowered in a high concentration of active carbon, which results in incomplete acetalization and further weakens the structure for shaping. On the other hand, by utilizing the support of porous PU polymer in the filter of the present invention, PVA can successfully be foamed in a new structure with big air pores or holes and more active carbon can be attached with less probability of failure. The quality of this new foam structure can be adjusted by slightly changing the percentages of the three kinds of materials and the parameters in the manufacturing process. For instance, changing the size of the air holes in the PU polymer or the ratio of PVA to active carbon will result in different softness, aeration, and filtration.

For the foam filter of the present invention, a foamed film comprising a mixture of PVA and active carbon is coated on the surface of PU foam. The foamed film of PVA and active carbon is prepared by mixing or reacting 20 to 70 wt % of PVA solution, 10 to 60 wt % of vegetable starch paste, 3 to 30 wt % of formaldehyde, 2 to 25 wt % of hydrochloric acid, and 0.5 to 40 wt % of active carbon together. Also the foam filter is trimmed depending on the demand.

The porous foam filter can be used as general foamed polymer materials, and functions as cushion materials, buffering materials, isolation materials, or noise-absorption materials. The new porous foam filter of the present invention can be applied for various purposes depending on the various shapes of foams and sizes of the pores. For example, the foam filter of the present invention can be used as a towel or a mask as the foam filter of the present invention is soaked into a harmless liquid such as soda solution (sodium bicarbonate solution), lemon water, or tea for the purpose of wet-filtering. The soaked foam filter of the present invention illustrated above can be even further packed in an airtight bag for the convenience of transportation. The foam filter can also be used for dry filtering purposes, such as the filtering net used in the air cleaner or the air conditioner. Furthermore, the foam filter of the present invention can filter the impurities, the toxins, the odors, or the molds in the air or in water. For example, the foam filter of the present invention can be used as a filter for the aquarium, an insole, or a cleaner for dirt.

### EXAMPLE 1

Materials listed in the table below are prepared.

| Materials | Weight (kg) | Wt % |
|---|---|---|
| PVA solution (PVA:water = 1:9) | 100 | 55.25 |
| Cornstarch solution (cornstarch:water = 1:3) | 40 | 22.10 |
| Formaldehyde (35 wt %) | 20 | 11.05 |
| Hydrochloric acid (30 wt %) | 15 | 8.29 |
| Active carbon | 6 | 3.31 |
| Total weight | 181 | 100.00 |

In addition to that, a bulk of PU foam with a porosity of 40 ppi is provided. The size of the PU foam is not limited as long as it can be soaked in the mixed solution illustrated in the above table.

Subsequently, 90 kilograms of water is added to a tank with a stirring device. 10 kilograms of PVA (BF-14 of Chang Chun Chemical Corp.,) are added slowly into the mixed solution. The mixed solution is heated to 100° C., stirred for 5 to 10 minutes, and then cooled to 50° C. to form a solution (A). 10 kilograms of cornstarch is mixed with 30 kilograms of water by heating to a temperature at 40° C. The cornstarch mixture is further stirred for 30 minutes to form a paste-type solution (B). Solution (A) and solution (B) are mixed completely to form solution (C). Afterward, 20 kilograms of formaldehyde, 15 kilograms of hydrochloric acid, and 6 kilograms of active carbon are added in sequence to form a soaking solution. A bulk of PU foam having a porosity of 40 ppi is then soaked into the soaking solution in the container. After that, the soaking solution in the container is heated to 60° C. to proceed the acetalization for 6 hours in a heating chamber. Then the soaking solution is cooled to room temperature. The bulk of the PVA foam is taken out, washed, dehydrated, and centrifuged at high speed. A bulk of modified PVA foam with a porosity of 80 to 150 ppi is obtained. Finally, the bulk of modified PVA foam is trimmed into strips or pieces, soaked in a sodium bicarbonate solution, and then packed in a wet-airtight package.

### EXAMPLE 2

Materials listed in the table below are prepared.

| Materials | Weight (kg) | Wt % |
|---|---|---|
| PVA solution (PVA:water = 1:8) | 90 | 35.29 |
| Cornstarch solution (cornstarch:water = 1:4) | 50 | 19.61 |
| Formaldehyde (35 wt %) | 15 | 5.88 |
| Hydrochloric acid (30 wt %) | 10 | 3.92 |
| Active carbon | 90 | 35.29 |
| Total weight | 255 | 100.00 |

The process for manufacturing is the same as that of example 1. The reaction conditions are also the same as those in example 1 except that the temperature for acetalization is 70° C. and the time for acetalization is 8 hours.

### EXAMPLE 3

Materials listed in the table below are prepared.

| Materials | Weight (kg) | Wt % |
|---|---|---|
| PVA solution (PVA:water = 1:10) | 30 | 24.39 |
| Cornstarch solution (cornstarch:water = 1:15) | 70 | 56.91 |
| Formaldehyde (35 wt %) | 10 | 8.13 |
| Hydrochloric acid (30 wt %) | 8 | 6.50 |
| Active carbon | 5 | 4.07 |
| Total weight | 123 | 100.00 |

The process for manufacturing is the same as that of example 1. The reaction conditions are the same as those in example 1 except that the temperature for acetalization is 75° C. and the time for acetalization is 12 hours. EXAMPLE 4

Materials listed in the table below are prepared.

| Materials | Weight (kg) | Wt % |
|---|---|---|
| PVA solution (PVA:water = 1:7) | 100 | 60.24 |
| Cornstarch solution (cornstarch:water = 1:3) | 28 | 16.87 |
| Formaldehyde (35 wt %) | 18 | 10.84 |
| Hydrochloric acid (30 wt %) | 15 | 9.04 |
| Active carbon | 5 | 3.01 |
| Total weight | 166 | 100.00 |

The process for manufacturing is the same as that of example 1. The reaction conditions are the same as those in example 1 except that the temperature for acetalization is 65° C. and the time for acetalization is 6 hours.

### EXAMPLE 5

Materials listed in the table below are prepared.

| Materials | Weight (kg) | Wt % |
|---|---|---|
| PVA solution (PVA:water = 1:8) | 100 | 42.55 |
| Cornstarch solution (cornstarch:water = 1:3) | 60 | 25.53 |
| Formaldehyde (35 wt %) | 25 | 10.64 |
| Hydrochloric acid (30 wt %) | 20 | 8.51 |
| Active carbon | 30 | 12.77 |
| Total weight | 235 | 100.00 |

The process for manufacturing is the same as that of example 1. The reaction conditions are the same as those in example 1 except that the temperature for acetalization is 70° C. and the time for acetalization is 3 hours.

### EXAMPLE 6

Materials listed in the table below are prepared.

| Materials | Weight (kg) | Wt % |
|---|---|---|
| PVA solution (PVA:water = 1:9) | 70 | 36.46 |
| Cornstarch solution (cornstarch:water = 1:3) | 50 | 26.04 |
| Formaldehyde (35 wt %) | 40 | 20.83 |
| Hydrochloric acid (30 wt %) | 30 | 15.63 |
| Active carbon | 2 | 1.04 |
| Total weight | 192 | 100.00 |

The process for manufacturing is the same as that of example 1. The reaction conditions are the same as those in example 1 except that the temperature for acetalization is 70° C., the time for acetalization is 2 hours, and 150 grams of calcium carbonate are added to increase the size of the air hole.

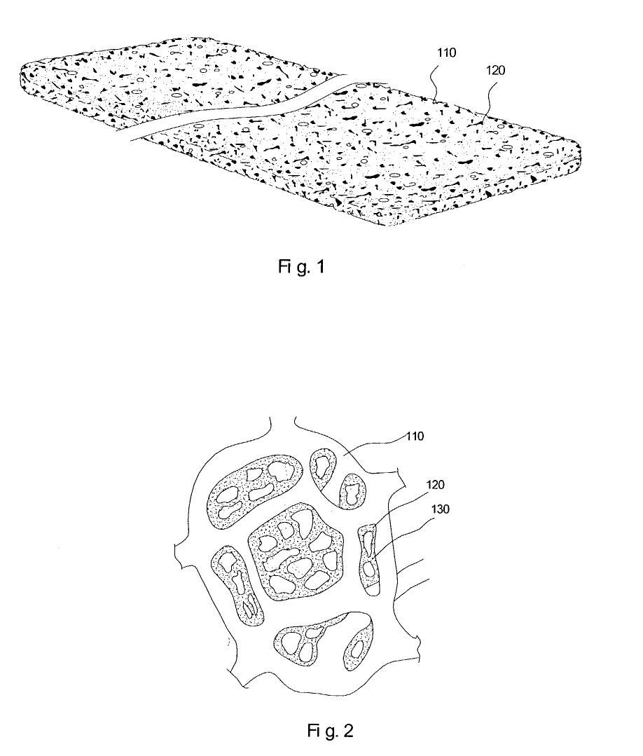

FIG. 1 shows the product obtained through the manufacturing process of the present invention. The structure as shown in FIG. 1 can have and remain the advantages such as the network-like polyurethane structure 110 for ventilation, the filter function and the moisture-absorbing ability of the PVA layer, homogeneous and high-density distribution of active carbons. Therefore, the new structure of foam filter of the present invention is excellent to be an anti-mildew, antiseptic, toxin-removing, odor-removing and ventilative structure. The detailed structure of the foam filter of the present invention is shown in FIG. 2. A PVA layer 120 with active carbon powders 130 dispersed therein. The PVA layer 120 coats on the surface of the porous PU structure 110 uniformly. The foam filter of the present invention is very flexible and suitable for contact on the skin of human beings. Besides, the foam filter of the present invention can be used especially for escaping from a fire because of their filtering, and for keeping moisture inside.

The selection or the combination of raw materials such as porous PU polymer materials, PVA, and active carbon is very important for the filter of the present invention. If only PVA and active carbon are included, the viscosity of PVA will be lowered in a high concentration of active carbon, which results in incomplete acetalization and further weakens the structure for shaping. On the other hand, by using the support of porous PU polymer in the filter of the present invention, PVA can successfully be foamed in a new structure with big air pores or holes and more active carbon can be attached with less probability of failure. The quality of this new foam structure such as the water contents as the foam filter is wetted, the ventilation of air and the density of the active carbon can be adjusted by slightly changing the percentages of the three kinds of materials and the parameters in manufacturing process.

The PVA layer of the foam filter of the present invention has smaller pores so that it can capture the dust and particles in the air. Also the dispersed active carbon in the PVA layer adsorbs the toxin in the air. Compared with the traditional filters, the filtering area of the PVA layer is increased greatly so that its filtering performance improves a lot. Particularly, by combining with PU foam, the foam filter of the present invention is more flexible and comfortable. Furthermore, since the water-keeping ability of PVA is better so that when there is a fire, it can lower the temperature of air inhaled and reduce the harm to the lungs. By taking advantage of good ventilation of traditional PU foam, the foam filter of the present invention can supply enough oxygen in an emergency. Thus the filtering capability of the present invention can be widely used for protecting people from air pollution, especially for helping fire victims to escape from an environment filled with hazardous compounds.

Although the present invention has been explained in relation to its preferred embodiment, it is to be understood that many other possible modifications and variations can be made without departing from the spirit and scope of the invention as hereinafter claimed.

What is claimed is:

1. A method for manufacturing a foam filter comprising the following steps:
(a) Mixing the polyvinyl alcohol (PVA) with water by heating and stirring until the PVA is dissolved to form a solution (A) and then cooling said solution (A);
(b) Mixing the vegetable starch with water by heating and stirring to form a paste-type solution (B);
(c) Mixing said solution (A) with said solution (B) completely to form a solution (C);
(d) Adding formaldehyde, catalyst and active carbon into said solution (C) to form a paste mixture;
(e) Soaking a polyurethane (PU) foam into said paste mixture;
(f) Heating said paste mixture to acetalize said PVA therein; and
(g) Cooling said paste mixture and washing said foam.

2. The method as claimed in claim 1, wherein step (g) further comprising dehydrating and trimming said foam.

3. The method as claimed in claim 1, wherein the heating temperature ranges from 80 to 120° C. and the cooling temperature ranges from 20 to 70° C. in step (a).

4. The method as claimed in claim 1, wherein the heating temperature ranges from 20 to 60° C. in step (b).

5. The method as claimed in claim 1 further comprising adding calcium carbonate in step (d)

6. The method as claimed in claim 1, wherein said catalyst in step (d) is hydrochloric acid.

7. The method as claimed in claim 1, wherein the temperature for acetalization ranges from 40 to 80° C. and the time for acetalization is less than 24 hours in step (f).

8. A foam filter which is made by coating a layer of mixture containing polyvinyl alcohol (PVA) and active carbon on a polyurethane (PU) foam, wherein said mixture is made by mixing at least 20 to 70 wt % of PVA solution, 10 to 60 wt % of vegetable starch paste, 3 to 30 wt % of formaldehyde, 2 to 25 wt % of catalyst, and 0.5 to 40 wt % of active carbon.

9. The foam filter as claimed in claim 8, wherein said catalyst is hydrochloric acid.

10. The foam filter as claimed in claim 8, wherein said filter is trimmed or cut.

11. The foam filter as claimed in claim 8, wherein said PVA is coated on said PU foam by soaking.

12. The foam filter as claimed in claim 8, wherein said filter is packed in a solution, containing an anti-mold agent, an antiseptic, or a sterilizer.

13. The foam filter as claimed in claim 8, wherein said filter is used for filtering the impurities, the toxins, the odors, or the molds in the air or water.
